(19) United States
(12) Patent Application Publication
(10) Pub. No.: US 2009/0231613 A1
(43) Pub. Date: Sep. 17, 2009

(54) Image processing apparatus and method of controlling the same

(75) Inventor: Hiroki Imai, Shiojiri-shi (JP)

Correspondence Address: EDWARDS ANGELL PALMER & DODGE LLP, P.O. BOX 55874, BOSTON, MA, 02205, US

(73) Assignee: Seiko Epson Corporation, Tokyo (JP)

(21) Appl. No.: 12/381,455

(22) Filed: Mar. 12, 2009

(30) Foreign Application Priority Data
Mar. 13, 2008 (JP) 2008-064124

(51) Int. Cl. G06F 3/12

(52) U.S. Cl. 358/1.15

(57) ABSTRACT

An image processing apparatus that can be connected to a printer includes: an image data storage unit that stores image data of a first data format which can be printed by the printer and image data of a second data format which cannot be printed by the printer; a print image designating unit that allows a user to designate image data to be printed from the image data storage unit; a print job generating unit that generates image data identification information corresponding to the designated image data and generates a print job including the image data identification information; and a print job transmitting unit that transmits the print job generated by the print job generating unit to the printer. When the designated image data is the image data of the second data format, the print job generating unit generates the image data identification information and generates the print job, without converting the second format into the first format.

### CROSS REFERENCES TO RELATED APPLICATIONS

The present invention contains subject matter related to Japanese Patent Application No. 2008-064124 filed in the Japanese Patent Office on Mar. 13, 2008, the entire contents of which are incorporated herein by reference.

### BACKGROUND

1. Technical Field

The present invention relates to an image processing apparatus and a method of controlling the same, and more particularly, to an image processing apparatus capable of reducing the overall printing time and a method of controlling the same.

2. Related Art

Some digital cameras, which are high-performance solid-state imaging apparatuses, have a structure in which raw data generated by an imaging device when a digital camera captures an image can be output to the outside of the digital camera. In general, an image file of raw data is obtained by converting an electric signal obtained from an imaging device, such as a CCD, into digital data. The image file of the raw data is output from the digital camera to a hard disk drive provided in an image processing apparatus, such as a personal computer or a photo viewer, and then stored therein.

When the image processing apparatus stores raw data as an image file and the user wants to print the image file of the raw data using a printer, it is difficult for most of the printers to print the image file of the raw data without processing the raw data. Therefore, the image processing apparatus needs to convert the image file of the raw data into an image file of JPEG data that can be printed by the printer and transmit the converted image file to the printer.

However, since the image file of the raw data has a large size, it takes a long time to convert the raw data into JPEG data. Therefore, when the printer continuously prints a plurality of image files held in the image processing apparatus, the user waits for a long time until all the image files are completely printed.

Therefore, it is conceivable to provide a structure in which an image processing apparatus simultaneously performs a print control process of monitoring the printing state of a printer and a process of converting the next raw image file to be printed into a JPEG image file to reduce the waiting time of the user.

In addition, a PictBridge standard has been used as a connection standard between an image processing apparatus and a printer. The PictBridge standard directly connects the image processing apparatus and the printer, without a computer interposed therebetween, such that the printer performs printing. The PictBridge standard supports only the image data file of the JPEG format, and it is difficult to designate an image file of raw data in a print job without processing the image file. Therefore, when the image file of raw data is transmitted to the printer, it is difficult for the printer to print the image file of raw data.

The above-mentioned problem arises when the image processing apparatus and the printer are connected to each other by a standard that does not support the image file of raw data, as well as when the image processing apparatus and the printer are connected to each other by the PictBridge standard. In addition, the above-mentioned problem arises when the printer prints an image of image data having a format that is not supported by a connection standard between the image processing apparatus and the printer, as well as when the printer prints the image file of raw data.

### SUMMARY

An advantage of some aspects of the invention is that it provides an image processing apparatus that is connected to a printer, can print an image including image data of a format that is not supported by the connected printer, and can reduce the print waiting time of a user.

According to an aspect of the invention, there is provided an image processing apparatus that can be connected to a printer. The image processing apparatus includes: an image data storage unit that stores image data of a first data format which can be printed by the printer and image data of a second data format which cannot be printed by the printer; a print image designating unit that allows a user to designate image data to be printed from the image data storage unit; a print job generating unit that gives image data identification information to each of the designated image data to generate a print job; a print job transmitting unit that transmits the print job generated by the print job generating unit to the printer; and a data format converting unit that converts the image data of the second data format into the first data format after the print job transmitting unit transmits the print job to the printer. When the designated image data is the image data of the second data format, the print job generating unit gives the image data identification information to the designated image data to generate the print job, without converting the second format into the first format.

The image processing apparatus according to the above-mentioned aspect may further include: a transmission request receiving unit that receives an image data transmission request from the printer; and an image data transmitting unit that transmits image data corresponding to the transmission request received by the transmission request receiving unit. When there is the image data of the first data format, the image data transmitting unit transmits the image data of the first data format to the printer. When there is no image data of the first data format, the data format converting unit converts the image data of the second data format into the first data format, and the image data transmitting unit transmits the converted image data to the printer.

The image data identification information may be information including a number, and the data format converting unit may convert the image data from the second data format into the first data format in increasing order of the number of the image data identification information given to the image data.

The data format converting unit may sequentially convert the image data of the second data format into the first data format, and the converted image data may be stored in a conversion data storage unit. The image data transmitting unit may acquire the converted image data from the conversion data storage unit, and transmit the acquired image data to the printer.

The first data format may be a JPEG data format, and the second data format may be a raw data format, which is a data format obtained from an imaging device.

The printer may be connected by a PictBridge standard.

In this case, it is possible to designate the image data of the first data format as a print target in the print job, but it may be difficult to designate the image data of the second data format as a print target.

According to another aspect of the invention, there is provided a method of controlling an image processing apparatus that can be connected to a printer. The method includes: allowing a user to designate image data to be printed from an image data storage unit that stores image data of a first data format which can be printed by the printer and image data of a second data format which cannot be printed by the printer; giving image data identification information to each of the designated image data to generate a print job; transmitting the generated print job to the printer; and converting the image data of the second data format into the first data format after the print job is transmitted to the printer. In the generating of the print job, when the designated image data is the image data of the second data format, the image data identification information is given to the designated image data to generate the print job, without converting the second format into the first format.

### BRIEF DESCRIPTION OF THE DRAWINGS

The invention will be described with reference to the accompanying drawings, wherein like numbers reference like elements.

FIG. 1 is a block diagram illustrating an example of the overall structure of a printing system and an example of the internal structure of an image processing apparatus according to an embodiment of the invention.

FIG. 2 is a flowchart illustrating a printing process of the image processing apparatus shown in FIG. 1.

FIG. 3 is a diagram illustrating the processes of the image processing apparatus and a printer when the image processing apparatus shown in FIG. 1 performs the printing process.

FIG. 4 is a diagram illustrating an example of a print file selecting screen displayed on a display unit of the image processing apparatus shown in FIG. 1.

FIG. 5 is a diagram illustrating an example of a print setting screen displayed on the display unit of the image processing apparatus shown in FIG. 1.

FIG. 6 is a diagram illustrating an example of a print progress screen displayed on the display unit of the image processing apparatus shown in FIG. 1.

FIG. 7 is a diagram illustrating an example of a print completion screen displayed on the display unit of the image processing apparatus shown in FIG. 1.

### DESCRIPTION OF EXEMPLARY EMBODIMENTS

Hereinafter, exemplary embodiments of the invention will be described with reference to the accompanying drawings. The following embodiments do not limit the technical scope of the invention.

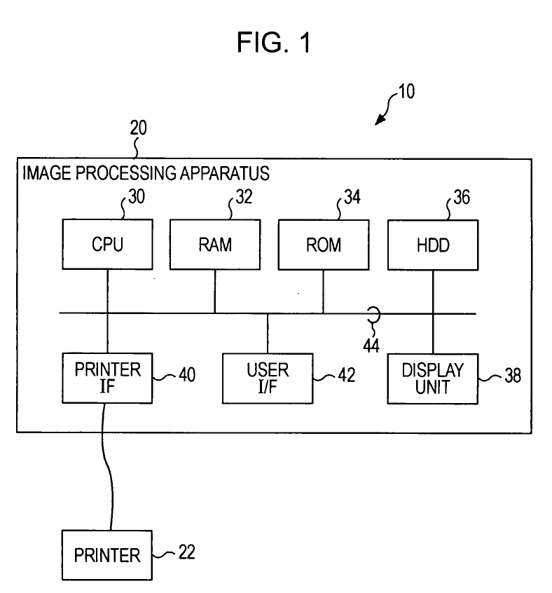

FIG. 1 is a block diagram illustrating the overall structure of a printing system 10 according to an embodiment of the invention. As shown in FIG. 1, the printing system 10 according to this embodiment includes an image processing apparatus 20 and a printer 22 that is connected to the image processing apparatus.

The image processing apparatus 20 is composed of, for example, a personal computer or a photo viewer, and the printer 22 is composed of an ink jet printer or a laser printer.

The image processing apparatus 20 according to this embodiment includes a CPU (central processing unit) 30, a RAM (random access memory) 32, a ROM (read only memory) 34, a hard disk drive 36, a display unit 38, a printer interface 40, and a user interface 42, which are connected to one another by an internal bus 44.

The CPU 30 forms a control unit that performs various control operations of the image processing apparatus 20. The RAM 32 volatilely stores various data or programs, and forms a volatile storage device according to this embodiment. The ROM 34 non-volatilely stores various data or programs, and forms a non-volatile storage device according to this embodiment. The hard disk drive 36 is an example of a rewritable storage device. In this embodiment, particularly, the hard disk drive 36 stores image data of image files captured by a solid-state imaging apparatus, such as a digital camera. The hard disk drive 36 forms an auxiliary storage device according to this embodiment.

The display unit 38 may be composed of, for example, an LCD (liquid crystal display). In this embodiment, for example, an image generated on the basis of image data stored in the hard disk drive 36 is displayed on the display unit 38.

The printer interface 40 is composed of a standardized interface, such as a USB interface, and is connected to the printer 22. In particular, in this embodiment, the image processing apparatus 20 and the printer 22 are connected to each other by a PictBridge standard. The use of the PictBridge standard makes it possible for a user to input various instructions to the image processing apparatus 20, thereby performing printing.

The user interface 42 may include, for example, a plurality of push buttons, a keyboard, and a mouse. When the display unit 38 is a touch panel, the user interface may also serve as the display unit 38. The user can use the user interface 42 to input various instructions or data to the image processing apparatus 20.

As can be seen from the above description, the user can easily change the connection between the image processing apparatus 20 and the printer 22. Therefore, the user can carry the image processing apparatus 20 to a specific place and use it.

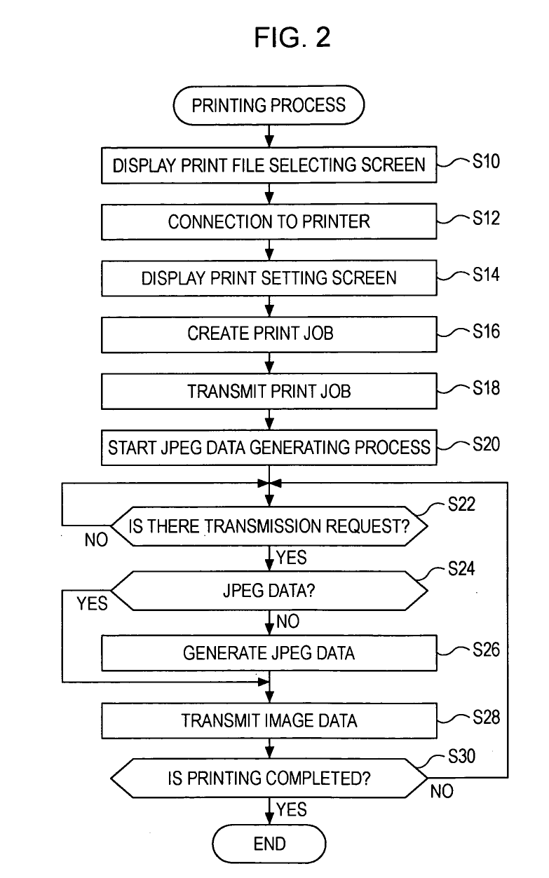

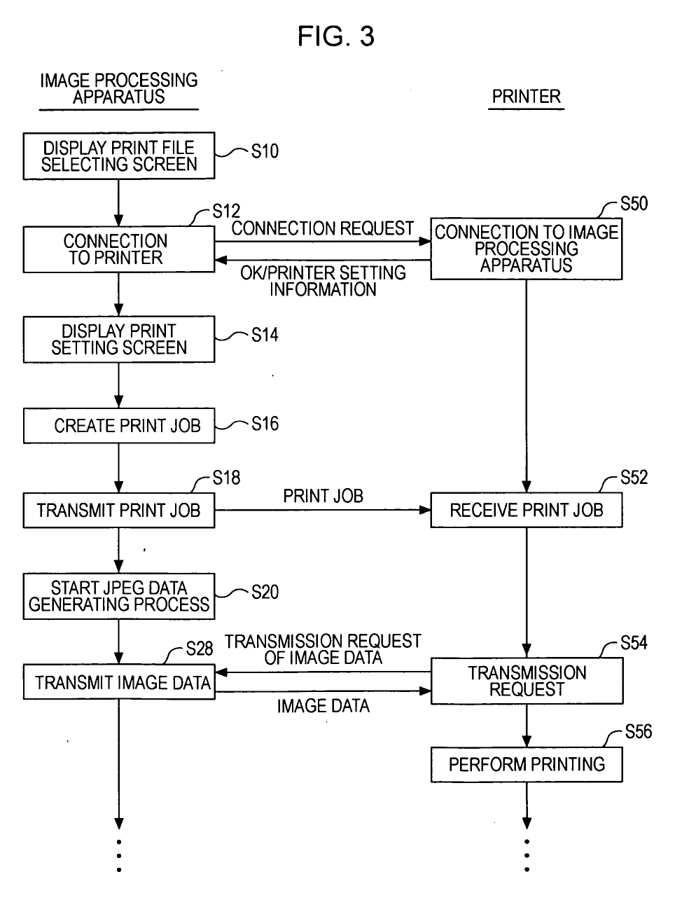

Next, the processes of the image processing apparatus 20 and the printer 22 when printing is performed will be described with reference to FIGS. 2 and 3. FIG. 2 is a flowchart illustrating an example of the printing process of the image processing apparatus 20 according to this embodiment. The printing process shown in FIG. 2 starts when the user inputs a printing instruction to the image processing apparatus 20. In addition, in order to perform the printing process shown in FIG. 2, the CPU 30 reads a printing process program stored in the ROM 34 or the hard disk drive 36 and executes the read program. FIG. 3 is a flowchart illustrating the message communication between the image processing apparatus 20 and the printer 22, and the process of the printer 22 when the printing process shown in FIG. 2 is performed by the image processing apparatus 20.

As shown in FIGS. 2 and 3, when the printing process starts, the image processing apparatus 20 displays an image file selecting screen on the display unit 38 (Step S10).

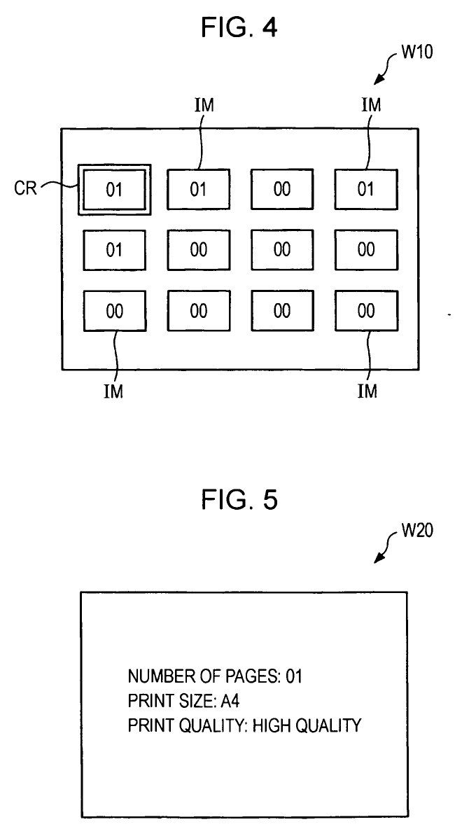

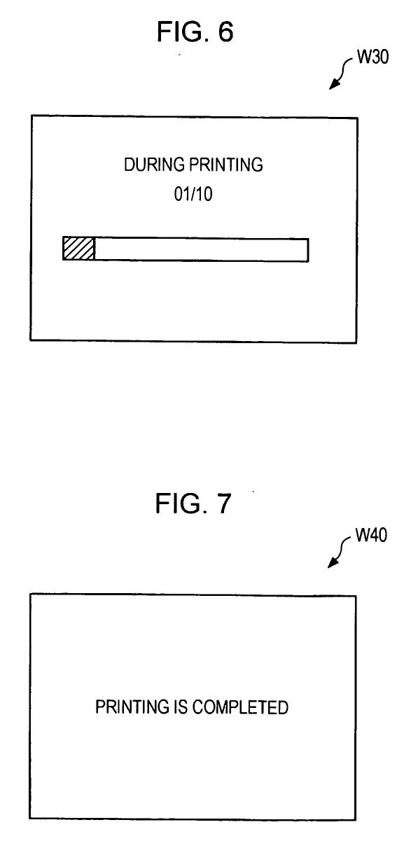

FIG. 4 is a diagram illustrating an example of an image file selecting screen W10 displayed on the display unit 38 according to this embodiment. As shown in FIG. 4, a list of images IM of the image file stored in the hard disk drive 36 is displayed on the image file selecting screen W10. The displayed images IM are of the image file stored in a folder designated by the user in the hard disk drive 36. The images IM are so-called reduced images. When the image file stored in the hard disk drive 36 includes reduced image data, the images are displayed on the basis of the reduced image data. When the image file does not include the reduced image data, the images are generated on the basis of the original image data.

A cursor CR is displayed on the image file selecting screen W10 that is displayed on the display unit 38. The user uses the user interface 42 to move the cursor CR, thereby selecting an image which the user wants to print and designating the number of pages. The number of pages designated by the user is displayed on the image as a numerical value.

In this embodiment, the image file having the images IM displayed on the image file selecting screen W10 includes RAW image data and JPEG image data. However, the user can select any image to be printed regardless of whether the image data is raw data or JPEG data.

When an image to be printed and the number of pages are designated, the user uses the user interface 42 to input information indicating the completion of the designation to the image processing apparatus 20. When receiving the information indicating the completion of the designation, the image processing apparatus 20 starts connection to the printer 22 (Step S12). That is, the image processing apparatus 20 transmits a connection request to the printer 22. Then, when receiving the connection request, the printer 22 accepts the connection (Step S50). When the connection request is normally received, the printer 22 transmits a response indicating the approval of the connection to the image processing apparatus 20. In addition, the printer 22 transmits printer setting information, such as the size of a printing sheet included in the printer 22 and print quality supported by the printer 22, to the image processing apparatus 20.

When receiving the printer setting information, the image processing apparatus 20 displays a print setting screen on the display unit 38 (Step S14). FIG. 5 is a diagram illustrating an example of a print setting screen W20 displayed on the display unit 38 according to this embodiment. As shown in FIG. 5, the number of pages, a sheet size, and print quality set by the user are displayed on the print setting screen W20. When the user wants to change the setting conditions, the user operates the user interface 42 to change the setting conditions.

The setting conditions that can be selected from the print setting screen W20 are based on the printer setting information received from the printer 22. For example, if the sizes of the printing sheets held in the printer 22 are A4 and B5, the user can select A4 or B5 from the print setting screen W20. In addition, for example, when the print quality supported by the printer 22 includes high-quality printing, high-speed printing, and normal printing, the user can select any one of the high-quality printing, the high-speed printing, and the normal printing from the print setting screen W20.

When the print setting is completed, the user uses the user interface 42 inputs information indicating the completion of the print setting to the image processing apparatus 20. When receiving the information indicating the completion of the print setting, the image processing apparatus 20 creates a print job on the basis of the image selected from the image file selecting screen W10 and the print setting conditions set by the print setting screen W20 (Step S16). The print job is a list of image files to be printed, and is generated by giving a file ID to each of the image files. In addition, the print job includes information related to the print setting of each of the image files.

In the PictBridge standard, an initial print job is transmitted to the printer, and the printer requests the transmission of each of the image data listed in the print job. In this case, an image file that can be designated as the print job is limited to image data of a JPEG format. However, in this embodiment, raw data in the image file is also converted into JPEG data in a pseudo manner, thereby giving a file ID to the image file. That is, raw data is not actually converted into JPEG data, but pseudo conversion is performed to give a file ID. This process makes it possible to generate a print job in a short time.

Specifically, when an initial image file to be printed is JPG data ‘Image01.JPG’, ‘Image01.JPG’ is listed in the print job as the file name of a print target file, and a file ID=00000001 is given to the image file. When the next image file to be printed is raw data ‘Image02.RAW’, ‘Image02.JPG’ is listed in the print job as the file name of a print target file, and a file ID=00000002 is given to the image file. As such, in this embodiment, even when raw data is used, it is regarded that a JPEG conversion process has been completed, and the file name of the data is also converted into a JPEG file name.

Then, the image processing apparatus 20 transmits the generated print job to the printer 22 (Step S18). As soon as the transmission of the print job is completed, the image processing apparatus 20 starts to convert raw data into JPEG data (Step S20). That is, the above-mentioned operation is performed when there is raw data in the image file that is designated as an image to be printed by the user. When there is raw data in the image file, the image processing apparatus 20 performs a process of developing the raw data without waiting for the reception of an image data transmission request from the printer 22, and compresses the developed image data in the JPEG format. The generated JPEG image data is temporarily stored in the hard disk drive 36.

When there is a plurality of image files including raw data in the list of print jobs, in this embodiment, the above-mentioned process is performed on the print jobs in the listed order. That is, raw data is converted into JPEG data in increasing order of file ID. This is because the printer 22 generally requests the transmission of image data in the order of the image files listed in the print job. That is, this is because the printer 22 requests the transmission of image data in increasing order of file ID.

Then, the printer 22 receives the print job transmitted from the image processing apparatus 20 (Step S52). Then, the printer 22 analyzes the received print job, and requests the transmission of image data of the image files that are not printed in the order of the image files (Step S54). That is, the printer selects the file ID of the image file that is not printed from the print job, designates the file ID, and requests the image processing apparatus 20 to transmit image data.

The image processing apparatus 20 determines whether an image data transmission request is received while converting raw data into JPEG data (Step S22). When the image data transmission request is received (Step S22: YES), the image processing apparatus 20 determines whether the designated image data is JPEG data (Step S24). That is, the image processing apparatus searches the designated image data from the hard disk drive 36, and determines whether there is JPEG image data.

When there is no JPEG image data (Step S24: NO), the image processing apparatus generates JPEG data on the basis of raw data of the designated image file (Step S26), and transmits the generated data to the printer 22 (Step S28). When there is JPEG image data (Step S24: YES), the image processing apparatus transmits the image data to the printer 22 without any change (Step S26).

For example, when the designated image file is JPEG image data, the image processing apparatus 20 transmits the JPEG data without any change, since the JPEG data is stored in the hard disk drive 36. On the other hand, when the designated image file is raw data, the raw data is converted into JPEG data by the JPEG data generating process in Step S20, and the JPEG data is stored in the hard disk drive 36. Then, the image processing apparatus transmits the JPEG data stored in the hard disk drive 36.

On the other hand, when the JPEG data generating process is not completed in Step S20 and JPEG data is not generated, the image processing apparatus 20 performs a developing process and a JPEG conversion process on raw data to generate JPEG data, and transmits the generated JPEG data to the printer 22. Therefore, in this case, a predetermined time is required to generate JPEG data.

After transmitting JPEG data as the image data, the image processing apparatus 20 determines whether to transmit all image data of the image files designated in the print job to the printer 22 (Step S30). When it is determined that all image data is not transmitted to the printer 22 (Step S30: NO), that is, when printing is not completed, the image processing apparatus 20 returns to Step S22 to wait for the reception of the next image data transmission request from the printer 22. When there is raw data that has not been converted into JPEG data, the image processing apparatus 20 sequentially performs the developing process and the JPEG conversion process on the raw data, while waiting for the reception of the next image data transmission request from the printer 22, thereby creating JPEG data in advance.

When it is determined that all image data is transmitted to the printer 22 (Step S30: YES), that is, when printing is completed, the image processing apparatus 20 ends the printing process.

When receiving JPEG data as the image data, the printer 22 prints the received data (Step S56). That is, the printer 22 performs printing on the basis of the received JPEG data. The printer 22 repeatedly performs Step S54 and Step S56 until the image files listed in the print job are removed. That is, the printer 22 repeatedly performs the process of requesting the transmission of image data and the printing process until all the images designated in the print job are printed.

While a series of printing processes is performed, the image processing apparatus 20 according to this embodiment displays a print progress screen W30 for notifying the progress of printing to the user on the display unit 38. When a series of printing processes is completed, the image processing apparatus 20 according to this embodiment displays a print completion screen W40 for notifying the completion of printing to the user on the display unit 38.

As such, according to this embodiment, even when image data, which is raw data, is included in the image file designated by the user, the image processing apparatus 20 generates a print job regarding that the raw data of the image file is converted into JPEG data, transmits the generated print job to the printer 22, and starts the JPEG data generating process. Therefore, the image processing apparatus can generate a print job in a very short time, and complete a JPEG data generating process while the printer 22 performs another process, such as a process of printing another image. As a result, when the printer 22 transmits an image data transmission request, the image processing apparatus can rapidly transmit JPEG data to the printer 22.

For example, when an image file that is given a file ID ‘00000001’ is JPEG data and an image file that is given a file ID ‘00000002’ is raw data in the print job, generally, the printer 22 requests the transmission of image data of the image file given the file ID ‘00000001’ at the beginning. Therefore, the image processing apparatus 20 can transmit JPEG image data given the file ID ‘00000001’ to the printer 22. While the printer 22 prints the image data, the image processing apparatus can generate JPEG data from the raw data given the file ID ‘00000002’ and store the generated data. As soon as a request for transmitting image data of the image file that is given the file ID ‘00000002’ is received from the printer 22, the image processing apparatus can transmit JPEG data to the printer 22, since the JPEG data has already been generated. In this way, it is possible to minimize the time required for the user to wait for the completion of printing.

The invention is not limited to the above-described embodiment, but various modifications and changes of the invention can be made. For example, in the above-described embodiment, JPEG data generated by the JPEG data generating process in Step S20 is stored in the hard disk drive 36. However, a storage device that stores the generated JPEG data is not limited to the hard disk drive 36. For example, when the storage capacity of the RAM 32 is large, the generated JPEG data may be stored in the RAM 32.

In the above-described embodiment, the generated JPEG data is stored in the JPEG format. However, the JPEG data may be further compressed or converted into an intermediate code to reduce the amount of data.

In the above-described embodiment, the JPEG data format is given as an example of the data format that can be printed by the printer 22, and the raw data format is given as an example of the data format that cannot be printed by the printer 22. However, the invention can be applied to other data formats.

In the above-described embodiment, the image processing apparatus 20 and the printer 22 are connected to each other by the PictBridge standard. However, the image processing apparatus 20 and the printer 22 may be connected to each other by other connection standards.

In the above-described embodiment, JPEG image data and raw image data are stored in the hard disk drive 36. However, a storage device that stores the image data is not limited to the hard disk drive 36. For example, when the image processing apparatus 20 is provided with a card slot, a memory card that stores image data may be inserted into the card slot, and the image processing apparatus 20 may read the image data stored in the memory card and acquire it.

In addition, a program for executing the printing process according to the above-described embodiment may be recorded on a recording medium, such as a flexible disk, a CD-ROM (compact disc-read only memory), a ROM, or a memory card, and then distributed in the form of the recording medium. In this case, the image processing apparatus 20 may read the program recorded on the recording medium and execute the read program to implement the above-described embodiment.

The image processing apparatus 20 may include an operating system or programs such as application programs. In this case, in order to use the programs included in the image processing apparatus 20, among the programs included in the image processing apparatus 20, a program including an instruction for calling a program that executes the same process as that in the above-described embodiment may be recorded on a recording medium.

The program may be distributed as a carrier wave through a network, without being distributed in the form of a recording medium. The program may be transmitted to the image processing apparatus 20 in the form of a carrier wave through the network, and the image processing apparatus may execute the program to implement the above-described embodiment.

When the program is recorded on the recording medium or when it is transmitted as a carrier wave through the network, the program may be encoded or compressed. In this case, the image processing apparatus 20 needs to read the program from the recording medium or the carrier wave and decode or decompress the read program.

In the above-described embodiment, the processes are performed by software. However, the processes may be performed by hardware, such as an ASIC (application specific IC). In addition, the processes may be performed by a combination of software and hardware.

What is claimed is:

1. An image processing apparatus that can be connected to a printer, comprising:
an image data storage unit that stores image data of a first data format which can be printed by the printer and image data of a second data format which cannot be printed by the printer;
a print image designating unit that allows a user to designate image data to be printed from the image data storage unit;
a print job generating unit that generates image data identification information corresponding to the designated image data and generates a print job including the image data identification information; and
a print job transmitting unit that transmits the print job generated by the print job generating unit to the printer,
wherein, when the designated image data is the image data of the second data format, the print job generating unit generates the image data identification information and generates the print job, without converting the second format into the first format.

2. The image processing apparatus according to claim 1,
wherein, in the print job, the image data of the first data format can be designated as a print target, but it is difficult to designate the image data of the second data format as a print target.

3. The image processing apparatus according to claim 1, further comprising:
a data format converting unit that starts to convert the image data of the second data format designated in the print job into the first data format after the print job transmitting unit transmits the print job to the printer.

4. The image processing apparatus according to claim 3,
wherein, before a request for transmitting the image data of the second data format is received from the printer, the data format converting unit starts to convert the image data requested to be transmitted into the first data format.

5. The image processing apparatus according to claim 3,
wherein the image data identification information is information including a number, and
the data format converting unit converts the image data from the second data format to the first data format in increasing order of the number of the image data identification information given to the image data.

6. The image processing apparatus according to claim 1,
wherein the first data format is a JPEG data format, and
the second data format is a raw data format, which is a data format obtained from an imaging device.

7. The image processing apparatus according to claim 1,
wherein the printer is connected by a PictBridge standard.

8. A method of controlling an image processing apparatus that can be connected to a printer, the method comprising:
allowing a user to designate image data to be printed from an image data storage unit that stores image data of a first data format which can be printed by the printer and image data of a second data format which cannot be printed by the printer;
giving image data identification information to each of the designated image data to generate a print job; and
transmitting the generated print job to the printer,
wherein, in the generating of the print job, when the designated image data is the image data of the second data format, the image data identification information is given to the designated image data to generate the print job, without converting the second format into the first format.
